(19) United States
(12) Patent Application Publication
(10) Pub. No.: US 2012/0075738 A1
(43) Pub. Date: Mar. 29, 2012

(54) INSPECTION APPARATUS AND INSPECTION METHOD FOR MAGNETIC HEAD OR MAGNETIC DISK AND INSPECTION METHOD FOR MAGNETIC HEAD

(75) Inventors: Toshiaki SUZUKI, Kamisato (JP); Kunihito HIGA, Kamisato (JP); Kazuhiko KISHIE, Kamisato (JP); Yoshihiro SAKURAI, Kamisato (JP)

(73) Assignee: HITACHI HIGH-TECHNOLOGIES CORPORATION, Tokyo (JP)

(21) Appl. No.: 13/211,660

(22) Filed: Aug. 17, 2011

(30) Foreign Application Priority Data
Sep. 24, 2010 (JP) 2010-213923

(51) Int. Cl. G11B 27/36

(52) U.S. Cl. 360/31; G9B/27.052; G9B/5.04

(57) ABSTRACT

An inspection apparatus and method for a magnetic head or a magnetic disk is conducted using a two-carriage method. In particular, the magnetic disk is rotated by a spindle, a test signal is written into the magnetic disk by one magnetic head mounted in one carriage which moves in the radius direction of the magnetic disk, and the test signal of the magnetic disk is read by the other magnetic head mounted in the other carriage which moves in the radius direction of the magnetic disk to inspect the performance of the magnetic head or the magnetic disk using the read signal. The sector pulses to determine servo timing at which servo burst signals preliminarily written into the disk are read are formed on the basis of a clock signal and an index signal generated along with the rotation of the spindle.

### BACKGROUND OF THE INVENTION

The present invention relates to an inspection apparatus and an inspection method for a magnetic head or a magnetic disk, and an inspection method for a magnetic head, and particularly to an inspection apparatus and an inspection method for a magnetic head or a magnetic disk, and an inspection method for a magnetic head in which a magnetic head or a magnetic disk is inspected by two sets of carriages.

The writing/reading performance of a magnetic head used in a magnetic disk apparatus is inspected by an inspection apparatus for a magnetic head. An inspection apparatus described in Japanese Patent Application Laid-Open No. H5-274641 conducts the inspection using one carriage. In the one-carriage method, a test signal is written or read by the same magnetic head. Accordingly, measurement data to be obtained comprehensively contain the writing and reading performance of a magnetic head to be inspected, and the writing performance cannot be distinguished from the reading performance. In addition, it is desirable to separately measure the writing performance and the reading performance for a recent highly-advanced head in order to inspect more precisely and strictly. Further, the recording density of a recent HDD has been continuously improved to several tens of gigabits/per inch.

On the other hand, an inspection apparatus described in Japanese Patent Application Laid-Open No. 2009-80923 is provided with two carriages, to one of which a standard magnetic head is provided and to the other of which a magnetic head to be inspected is provided, so that data are mutually written and read by the two magnetic heads to conduct a test for the performance of the magnetic head to be inspected.

### SUMMARY OF THE INVENTION

However, a recent magnetic recording density has been increased, and for example, the number of tracks exceeds 200000 per inch. The width of one track has been continuously made narrower to 0.1 μm or smaller. In an inspection by the one-carriage method, positional accuracy by a spindle motor, RRO (Repeatability Run Out) oscillation, and the trajectory of a magnetic head (hereinafter, simply referred to as a head) on a magnetic disk (hereinafter, simply referred to as a disk) are the same in writing and reading.

On the other hand, writing and reading positions are different from each other in a two-carriage method, and thus it is necessary to be synchronized with the timing. However, along with an increasing recording density, it is becoming difficult to be synchronized with the timing and to stably conduct an inspection. Further, it appears that eccentric occurs due to errors of the rotation accuracy of a spindle motor caused by arrangements of two carriages, or the RRO state of the spindle motor is seen in a different manner. Thus, it is becoming difficult to stably conduct an inspection. Further, along with an increasing recording density, it is becoming difficult to provide high-performance writing and reading elements for one magnetic head. It is becoming difficult to stably conduct an inspection by a method in which data are mutually written and read with two magnetic heads.

Accordingly, an object of the present invention is to provide an inspection apparatus or an inspection method for a magnetic head or a magnetic disk, and an inspection method for a magnetic head by which an inspection can be stably conducted in a two-carriage method.

In order to achieve the foregoing object, the present invention includes at least features described below.

A first aspect of the present invention is an inspection apparatus or method for a magnetic head or a magnetic disk, in which the magnetic disk is rotated by a spindle, a test signal is written into the magnetic disk by one magnetic head mounted in one carriage which moves in the radius direction of the magnetic disk, and the test signal of the magnetic disk is read by the other magnetic head mounted in the other carriage which moves in the radius direction of the magnetic disk to inspect the performance of the magnetic head or the magnetic disk using the read signal, wherein sector pulses to determine servo timing reading servo burst signals preliminarily written into the disk are formed on the basis of a clock signal and an index signal generated along with the rotation of the spindle.

Moreover, in a second aspect of the present invention, the clock signal is formed on the basis of a clock forming a rotation control clock signal that controls rotation control of a motor of the spindle.

Furthermore, in a third aspect of the present invention, the two sets of carriages are provided at positions located apart from each other by 180 degrees.

In addition, in a fourth aspect of the present invention, the index signal is generated one pulse per one turn of the spindle.

Moreover, in a fifth aspect of the present invention is an inspection method for a magnetic head, in which the magnetic disk is rotated by a spindle, a test signal is written into the magnetic disk by one magnetic head mounted in one carriage which moves in the radius direction of the magnetic disk, and the test signal of the magnetic disk is read by the other magnetic head mounted in the other carriage which moves in the radius direction of the magnetic disk to inspect the performance of the magnetic head using the read signal, wherein the one magnetic head mounted in the one carriage or the other magnetic head mounted in the other carriage is continued to be mounted to replace remained magnetic head between the one magnetic head and the other magnetic head, and to conduct a test for the performance of the remained magnetic head..

According to the present invention, it is possible to provide an inspection apparatus or an inspection method for a magnetic head or a magnetic disk, and an inspection method for a magnetic head by which an inspection can be stably conducted in a two-carriage method.

### BRIEF DESCRIPTION OF THE DRAWINGS

FIG. 1 is a block diagram of a magnetic head inspection apparatus according to an embodiment of the present invention;

FIG. 2 is a block diagram of a piezocartridge and an on-track servo circuit in FIG. 1;

FIG. 3 is a diagram for showing a plurality of tracks as areas formed in a ring shape on a disk and sectors obtained by dividing the tracks into plural;

FIG. 4 are diagrams for explaining a writing/reading method of an index signal, a sector pulse signal, a servo gate pulse signal, a servo burst signal and a servo signal necessary for inspecting a head;

FIG. 5 are diagrams for explaining the trajectories of the heads of carriages A and B generated by rotational positions of encoder pulses;

FIG. 6 are diagrams for schematically showing affects of a servo timing shift in the case of reading the servo burst signal;

FIG. 7 is a diagram for explaining the trajectory of the head generated by errors of mechanical structures of the carriages; and

FIG. 8 is a diagram for showing an inspection flow for a reading element of the magnetic head by the magnetic head inspection apparatus according to the embodiment of the present invention.

### DESCRIPTION OF THE PREFERRED EMBODIMENTS

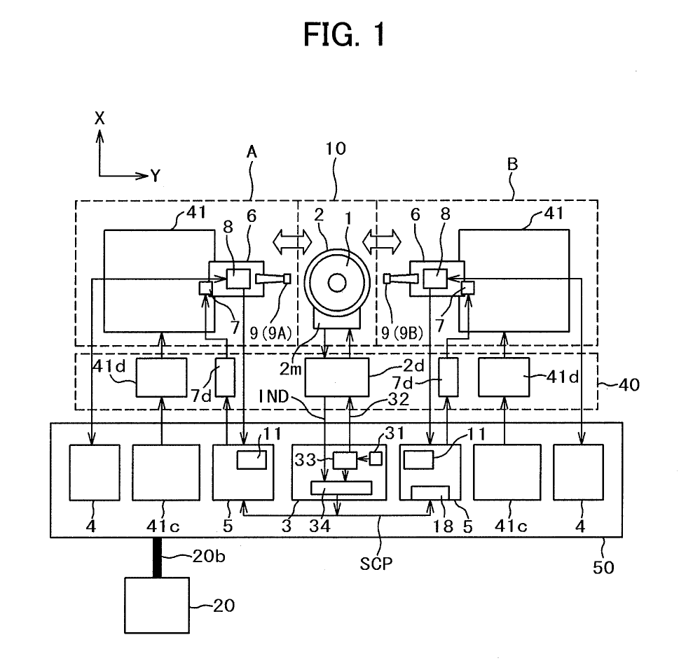

FIG. 1 is a block diagram of a magnetic head inspection apparatus (hereinafter, referred to as an inspection apparatus) 100 according to an embodiment of the present invention. The inspection apparatus 100 mainly includes a spindle unit 10 having a spindle 2 that allows a disk 1 for inspection to be rotated, two carriages A and B, a driver unit 40 that drives the spindle unit 10, piezoactuators, and the like, a test controlling unit 50 that controls the respective units to conduct a test, and a data processing/controlling apparatus 20 that integrally controls the respective units through a bus 20b to process measurement data.

The spindle 2 allows the disk to be detachably mounted, and is controlled by a spindle controller 3 through a spindle driver 2d.

The two carriages A and B have the same configuration, and thus will be explained without using the indexes A and B. The carriages are provided adjacent to the spindle 2, and each of the carriages includes a piezocartridge 6 in which a reading/writing (RW) amplifier 8 is mounted, a piezoactuator 7 that allows a head 9 to be slightly moved in the radial direction of the spindle 2 through the piezocartridge 6, and an X-Y stage 41 that allows the head 9 to be moved in the X-Y directions. The X-Y stage 41 is controlled by a mechanical controller 41c through an X-Y stage driver 41d. The piezoactuator 7 is controlled by a servo controller 5 through a piezodriver 7d. For example, when servo information is written into the disk, the head 9 can be moved with a distance resolution of about 1 nm.

The test controlling unit 50 includes data writing/reading circuits 4 in addition to the spindle controller 3, the servo controllers 5, and the mechanical controllers 41c.

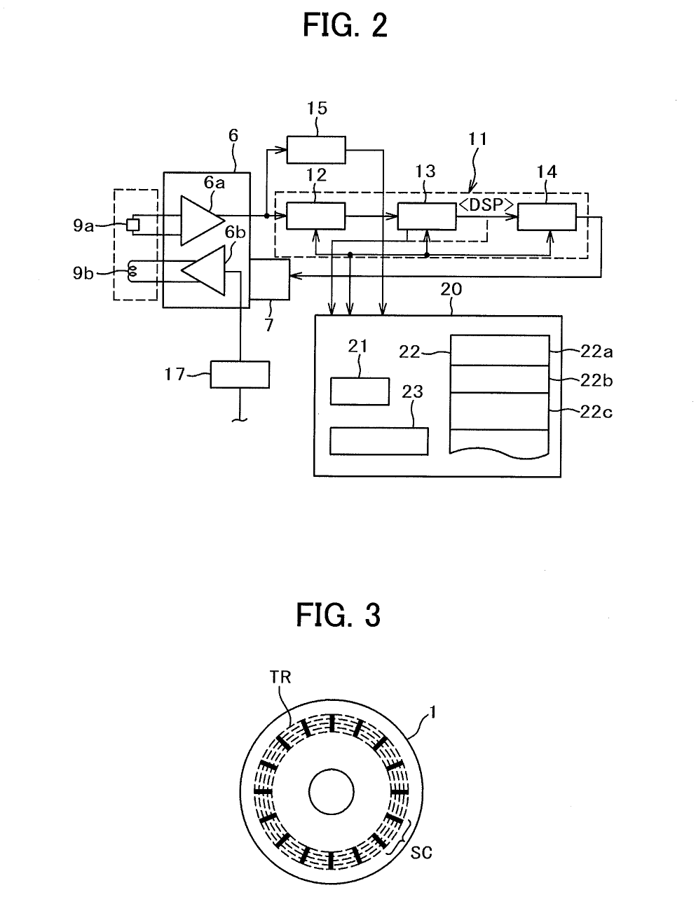

FIG. 2 is a block diagram of the piezocartridge 6 and an on-track servo circuit 11 in FIG. 1. The head 9 can be detachably mounted to the piezocartridge 6. As shown in FIG. 2, a reading amplifier 6a, a writing amplifier 6b, and the like are provided inside the piezocartridge 6. The reading amplifier 6a receives and amplifies a signal from a reading head 9A to be output to a data reading circuit 15 as well as the on-track servo circuit 11.

As shown in FIG. 2, the on-track servo circuit 11 includes a servo signal analytical circuit 12, a position demodulating circuit (position detection signal generating circuit) 13, and a position controlling circuit 14. The on-track servo circuit 11 is activated by the data processing/controlling apparatus 20.

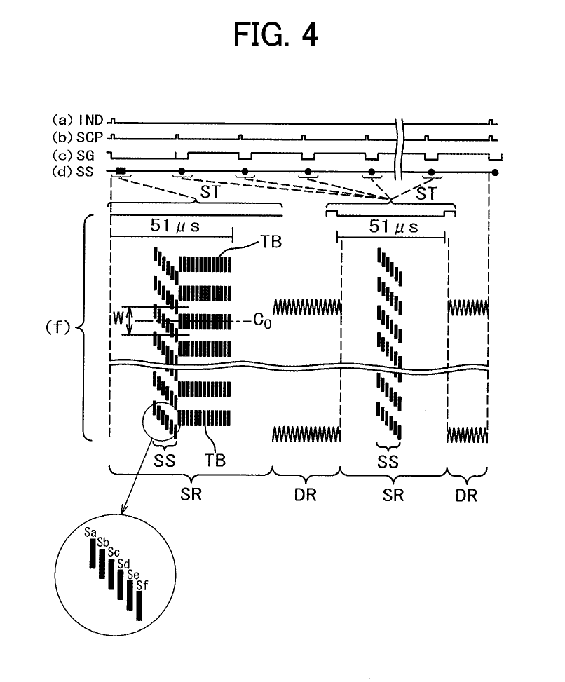

As shown in FIG. 3, the disk 1 has a plurality of tracks TR as areas formed in a ring shape and sectors SC obtained by dividing the tracks TR into 1024 pieces. As shown in FIG. 4F, each sector SC includes a servo area SR that is provided at the forefront and has servo burst signals and a data area DR following the servo area SR.

Each of the servo burst signals SS is composed of six servo signals A to F as shown in FIG. 4F. Given that W is assumed as a read track width, the six servo signals Sa, Sb, Sc, Sd, Se, and Sf (see the extracted diagram in FIG. 4) overlap each other by 2W/3 in the radius direction, and are formed while being separated from each other by predetermined intervals in the track direction. The middle position of the servo signal F serves as a boundary between the tracks.

The servo signal analytical circuit 12 shown in FIG. 2 receives a reading signal from the reading amplifier 6a to amplify each of the six servo signals Sa, Sb, Sc, Sd, Se, and Sf, and outputs voltage signals representing the amplitude levels of the servo signals to the position demodulating circuit 13. The position demodulating circuit 13 calculates a positional shift from a center line Co (see FIG. 4F) of the data track TR to be output to the position controlling circuit 14. The position controlling circuit 14 outputs to the piezoactuator 7 a driving signal (voltage signal) at a predetermined level to return the position of the head 9 to the center line Co of the track TR on the basis of the positional shift calculated by the position demodulating circuit 13. Thereby, the position of the head 9 is corrected (servo following), and the head 9 is positioned at a target track in an on-track state.

It should be noted that the servo signal analytical circuit 12, the position demodulating circuit 13, and the position controlling circuit 14 are actually provided as DSP (digital signal processor) circuits having the above-described functional circuits as shown by the dotted line. In addition, when the head 9 is positioned at the center line Co of the track TR, the driving signal (voltage signal) from the position controlling circuit 14 is kept at constant voltage, and the position of the head 9 is kept at the center line Co of the track TR.

The data reading circuit 15 receives a signal from the reading amplifier 6a and digitalizes reading data to be transmitted to the data processing/controlling apparatus 20. A servo signal/data writing circuit 17 writes the data and the servo signals into the track on the basis of a command from the data processing/controlling apparatus 20. The data processing/controlling apparatus 20 includes an MPU 21, a memory 22, and an interface 23 for the above-described respective circuits. The memory 22 has a servo signal setting program 22a, a head access program 22b, and a data reading/writing controlling program 22c, and controls the respective circuits.

A writing and reading method of the servo signals necessary for inspecting the head 9 will be described using FIGS. 4. A (a) signal shown in FIG. 4 shows an index signal IND indicating a start position of each track TR. A (b) signal shown in FIG. 4 shows a sector pulse SCP indicating a start position of each sector on the basis of the IND signal. A (c) signal shown in FIG. 4 shows a servo gate pulse signal SG that specifies a period “ST” during which the sector pulse SCP forming servo timing is triggered and the servo burst signal SS is written or read into/from the servo area SR. A (d) signal shown in FIG. 4 shows a servo burst signal SS that is written or read during the period “ST” specified by the servo gate pulse signal SG. In addition, FIG. 4F is a detailed explanation diagram of the servo burst signals SS. It should be noted that after detecting the index signal IND, track numbers TB are written into the first servo area SR together with the servo burst signals.

On the basis of the index signal IND, the sector pulses SCP the number of which corresponds to that of sectors of one circle, namely, one track TR, for example, 1024 of divided sector pulses are generated. As means for dividing into 1024, the sector pulses SCP have been generated using encoder pulses generated from a spindle motor 2m that rotates the spindle 2 to determine the timing.

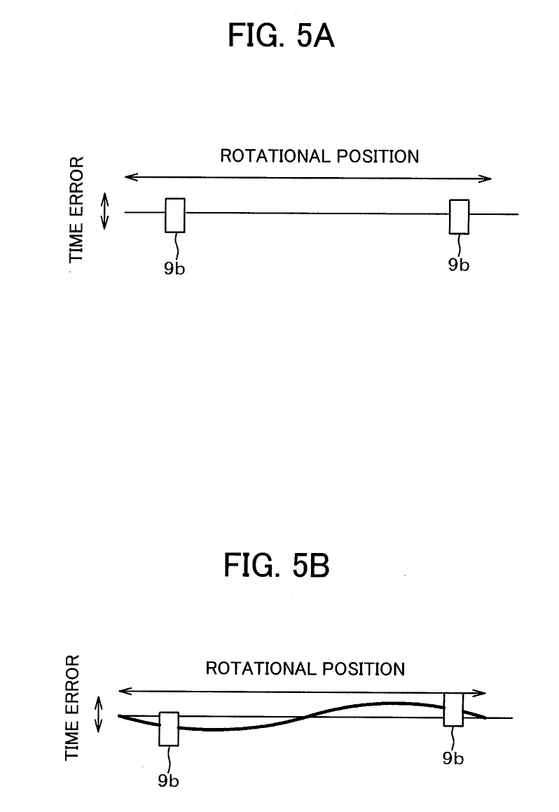

However, the encoder pulses cause periodical time errors such as eccentric as shown in FIG. 5B due to eccentric errors of the slit accuracy for encoder signals and errors of positions where sensors and slits are mounted. The time errors caused by the encoder pulses result in timing shifts of the sector pulses (SCP). As shown in FIG. 5B, in general, the time errors of the encoder pulses due to eccentric lead to a periodical error (timing shift) in one turn in which the time error gradually becomes shorter in one turn and then becomes longer and vice versa. As described above, the sector pulses SCP (servo timing) formed on the basis of the encoder pulses are periodically changed in a turn of the motor. It should be noted that FIG. 5A schematically shows a state in which ideal servo timing with no time errors due to the rotational position caused by the encoder can be obtained.

As described above, the servo burst signals SS are written and read at the servo timing of the sector pulses SCP. However, the servo signals are written and read with the same head 9 in a one-carriage method, and thus a temporal shift of the servo timing is not large.

On the other hand, the servo burst signals SS are written or read by one of two heads located at different positions and are read or written by the other in a two-carriage method. Thus, a temporal shift of the servo timing due to the rotational position is large.

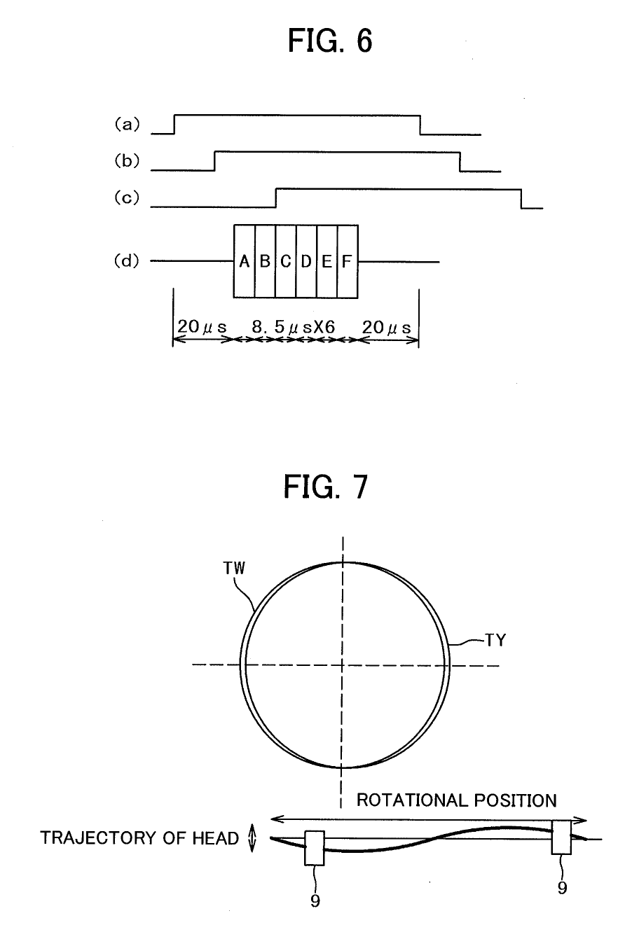

FIG. 6 schematically show an example of affects of the servo timing shift when reading the servo burst signals SS. FIG. 6D shows an example of the servo burst signals SS written by one of the heads 9. The servo burst signals A to F, each having a width of 8.5 μs, are written while providing margins of 20 μs in the front and back. It is assumed that these signals are read by the other head located apart by, for example, 180 degrees.

The signal (a) shows a case in which no servo timing shift occurs at all. The signal (b) shows a case in which the servo timing is delayed by about 15 μs. The signal (c) shows a case in which the servo timing is delayed by about 40 μs. As well as the signal (a), the servo burst signals SS in the case of the signal (b) can be read and on-track control can be performed. All the servo signals in the case of the signal (c) cannot be read, and thus the on-track control cannot be performed. As a result, data of at least this sector cannot be read. In consideration of the above-described periodicity, a certain range of the sector cannot be on-tracked, and data cannot be read. Namely, the data cannot be stably read.

Accordingly, it is necessary to provide means for reducing or eliminating the periodical time shift. Hereinafter, an explanation will be given referring back to FIG. 1.

In the embodiment, a control clock 31 forming a rotation control clock signal 32 used for rotation control of the spindle motor 2m is used together with the encoder pulses shown in FIG. 1. The control clock 31 has a frequency several times that of the encoder pulse. In addition, the rotation control clock signal 32 is stabilized by a PLL (Phase Locked Loop) 33. Accordingly, the control clock 31 or the rotation control clock signal 32 obtained by frequency-dividing the control clock 31 are not changed due to the position during the rotation of the spindle, and thus ideal servo timing can be formed.

However, the point of origin of the spindle is unknown only with the control clock 31. Thus, as the point of origin, the index signal one pulse of which is generated during one turn of the spindle 2 is used to form the sector pulses SCP (servo timing).

The index signal IDX and the rotation control clock signal 32 formed by the control clock 31 are input to a servo timing forming circuit 34, and the stable sector pulses SCP with no time shift are formed as shown in FIG. 5A to be input to the servo controllers 5 of the carriages A and B. In the carriage B located apart from the carriage A by 180 degrees, the sector pulses SCP are formed by shifting the phase by 180 degrees using a 180-degree shift phase circuit 18. The servo burst signals can be reliably written or read by the sector pulses SCP. It should be noted that the rotation control clock signal 32 itself is used in the embodiment. However, a clock signal obtained by frequency-dividing the control clock 31 into a different frequency may be used. Hereinafter, the rotation control clock signal 32 forming the servo timing or the clock signal with a different frequency is referred to as a servo clock CLK.

In this case, for example, even if the rotation of the spindle 2 is stopped after the servo burst signals SS are written, the position of the servo timing can be generated at a certain position. It is not advantageous that the rotation of the spindle 2 is stopped, and thus the test is continued in a state where the rotation of the spindle 2 is not stopped as much as possible. However, for example, even if the rotation of the spindle 2 needs to be stopped in order to replace the head 9 to be described later, the test can be stably continued while rotating the spindle 2 again.

Further, since only one pulse of the index signal IDX is generated per one turn of the spindle, and the pseudo index signal IDX is generated for the carriage B by the 180-degree shift phase circuit 18 in the embodiment. However, the index signal IDX may be generated at a position shifted by 180 degrees to generate two pulses of the index signal IDX per one turn of the spindle.

As the clock signal forming the servo clock CLK, the control clock 31 used for rotation control of the spindle motor 2m is used in the embodiment. However, a clock itself or a clock formed by frequency dividing by which a frequency larger than the number of sector divisions in one track TR may be basically used.

According to the embodiment, it is possible to provide an inspection apparatus for stably inspecting a magnetic head in a two-carriage method having the heads located at different positions.

As described above, even if preferable servo timing is formed by the control clock 31 and the on-track control is performed, the position of the reading carriage is shifted due to errors of the mechanical structure in the X or Y direction of the carriage. The positional shift is seen by the reading carriage as being eccentric with respect to the writing carriage as shown in FIG. 7. Specifically, a read track TY is eccentric with respect to a written track TW.

Accordingly, only the servo burst signals SS are extracted before performing the on-track control to learn the shift due to eccentric. On the basis of the learning result, the shift is corrected by the feed forward control in the on-track control for performing the servo following, the error factors due to mechanical accuracy can be cancelled, and positional errors at the time of the on-track control can be considerably reduced.

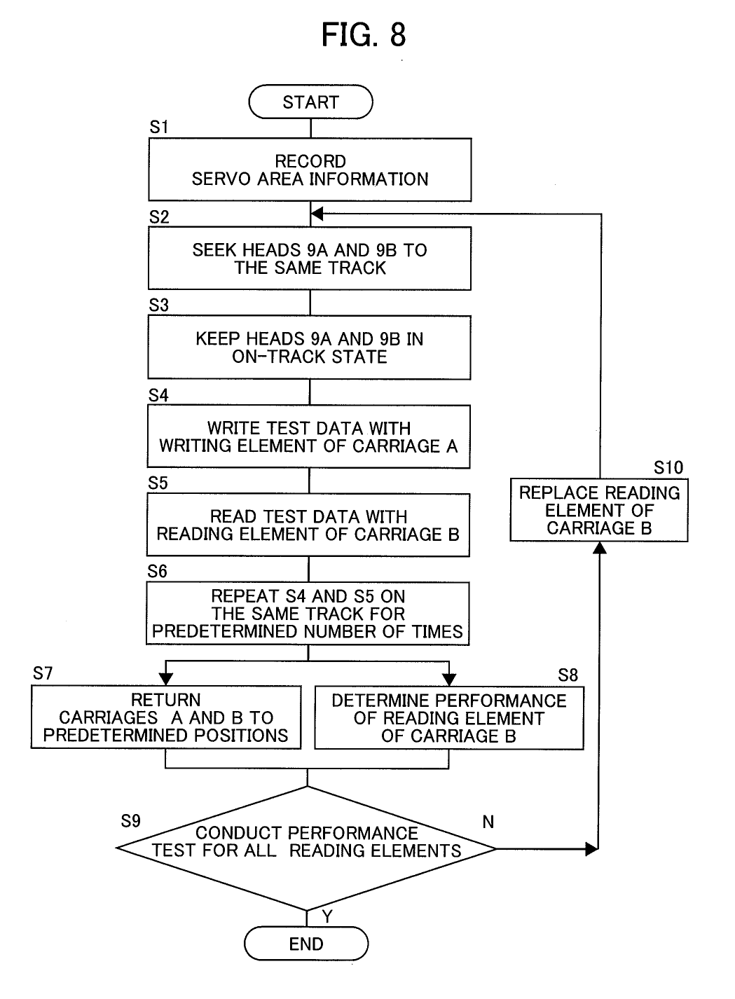

Next, an inspection flow of the reading element 9b (see FIG. 2) of the magnetic head in the magnetic head inspection apparatus 100 according to the embodiment will be described using FIG. 8. In the flow shown in FIG. 8, the servo timing formed of the IND signal and the servo clock CLK is used. Further, it is assumed in the flow that when performing the on-track control, the feed forward control using the learning effects shown in FIG. 7 is performed.

In addition, along with an increasing recoding density, it is becoming difficult to provide high-performance writing and reading elements for one magnetic head. Thus, a head 9A having a writing element with excellent characteristics is used for the carriage A to conduct a test for the characteristics of a reading element of a head 9B mounted in the carriage B. Further, the heads 9 of the carriages A and B are arranged at positions located apart from each other by 180 degrees.

In the first place, servo area information containing the servo burst signals SS is recorded, by the carriage A for writing, into the disk 1 with no data written at a servo area that is preliminarily positioned on the basis of the servo clock CLK (Step 1 (hereinafter, abbreviated as S1, and the same applies to S2 and the following steps)). It should be noted that the servo area information contains, in addition to the servo burst signals SS, information such as a marker signal indicating the beginning of the servo area and a sector number in an HDD. However, simple information of only the servo burst signals SS and track numbers TB is written at the time of the test as shown in FIG. 4F. Further, the track numbers TB are recorded only at the first sector.

Next, the heads 9A and 9B of the carriages A and B that are positioned apart from each other by 180 degrees, namely, that are symmetrically located with respect to the spindle 2 are sought (moved) to the same track (S2). Then, the servo following is performed by the reading elements of the carriages A and B to keep the heads 9A and 9B in an on-track control state (S3).

Next, test data are written into the data area DR with the writing element with excellent characteristics of the carriage A (S4), and the test data are read by the reading element of the carriage B as a test target (S5). The data writing and reading performed in S4 and S5 are repeated on the same track for a predetermined number of times (S6). Then, the carriages A and B are returned to predetermined positions such as standby positions (S7), and the performance of the reading element of the carriage B is determined using the reading data (S8).

It is determined whether or not the performance test for the all reading elements has been conducted (S9). If the performance test for the all reading elements has not been conducted, the reading element is replaced for the test (S10), and S2 to S8 are repeated. If the performance test for the all reading elements has been conducted, the flow is completed.

In the above-described inspection flow, the carriages A and B are positioned in the X and Y directions under the control of the mechanical controllers 41c.

The performance test for the reading element of the head 9 has been performed in the above description. However, the head 9 having the high-performance reading element is provided for one of the carriages A and B, and the performance test for the writing element provided for the head 9 of the other carriage can be also conducted similar to the flow shown in FIG. 7.

Further, in the above-described inspection flow, the high-performance head is used as an inspecting head (element) for inspecting a head (element) to be inspected. However, a head (element) whose performance has been known may be used.

According to the above-described embodiment of the inspection method for a head, the performance test for the head is conducted in the same radius, namely, on the same track. Thus, after data are written by one carriage, the data can be immediately read by the other carriage. Accordingly, the measurement can be easily performed, and the test time can be shortened.

Further, according to the above-described embodiment of the inspection method for a head, data can be written into the same track many times and measured immediately after writing. Thus, the measurement can be easily and stably performed, and a highly-reliable test can be conducted.

Further, according to the above-described embodiment of the inspection method for a head, it is only necessary to replace only the head to be inspected. Thus, the inspection time can be shortened as compared to a case in which the heads of the both carriages are replaced after inspecting the both.

However, even in the method of replacing the heads of the both carriages after inspecting the both, the same effects can be obtained by using the servo timing formed of the index signal IND and the control clock 31.

Further, according to the above-described embodiment, it is possible to provide an inspection method of stably inspecting a magnetic head even in the two-carriage method having heads located at different positions.

In the above-described embodiment, the inspection for a magnetic head has been described. Even for an inspection for a magnetic disk, the inspection apparatus of the embodiment is used or the inspection method of the embodiment is performed while a high-performance writing element or a writing element whose performance has been known is used for one of the heads of the carriages A and B and a high-performance reading element or a reading element whose performance has been known is used for the other of the heads of the carriages A and B. Accordingly, it is possible to provide an inspection apparatus or an inspection method for a magnetic disk that enables a stable inspection.

What is claimed is:

1. An inspection apparatus for a magnetic head or a magnetic disk, the apparatus comprising: two sets of carriages in each of which the magnetic head is mounted and which move in the radius direction of the magnetic disk; a spindle which allows the magnetic disk to be rotated; a test signal is written into the magnetic disk by the magnetic head of one of the two sets of carriages; and the test signal is read by the magnetic head of the other carriage to inspect the performance of the magnetic head or the magnetic disk using the read signal, wherein
sector pulses to determine servo timing for reading servo burst signals preliminarily written into the disk are formed on the basis of a clock signal and an index signal generated along with the rotation of the spindle.

2. The inspection apparatus for a magnetic head or a magnetic disk according to claim 1, wherein
the clock signal is formed on the basis of a clock forming a rotation control clock signal that controls the rotation of a motor of the spindle.

3. The inspection apparatus for a magnetic head or a magnetic disk according to claim 1, wherein
the two sets of carriages are provided at positions located apart from each other by 180 degrees.

4. The inspection apparatus for a magnetic head or a magnetic disk according to claim 1, wherein
the index signal is generated one pulse per one turn of the spindle.

5. The inspection apparatus for a magnetic head or a magnetic disk according to claim 1, wherein
a positional shift generated by structural errors of the carriages is preliminarily learned, and on-track control for performing servo following is corrected on the basis of the learning result.

6. An inspection method for a magnetic head or a magnetic disk, in which the magnetic disk is rotated by a spindle, a test signal is written into the magnetic disk by one magnetic head mounted in one carriage which moves in the radius direction of the magnetic disk, and the test signal of the magnetic disk is read by the other magnetic head mounted in the other carriage which moves in the radius direction of the magnetic disk to inspect the performance of the magnetic head or the magnetic disk using the read signal, wherein
sector pulses to determine servo timing for reading servo burst signals preliminarily written into the disk are formed on the basis of a clock signal and an index signal generated along with the rotation of the spindle.

7. The inspection method for a magnetic head or a magnetic disk according to claim 6, wherein
the clock signal is formed on the basis of a clock forming a rotation control clock signal that controls rotation control of a motor of the spindle.

8. The inspection method for a magnetic head or a magnetic disk according to claim 6, wherein
the two sets of carriages are provided at positions located apart from each other by 180 degrees.

9. The inspection method for a magnetic head or a magnetic disk according to claim 6, wherein
the index signal is generated one pulse per one turn of the spindle.

10. The inspection method for a magnetic head or a magnetic disk according to claim 6, wherein
a positional shift generated by structural errors of the carriages is preliminarily learned, and on-track control for performing servo following is corrected on the basis of the learning result.

11. An inspection method for a magnetic head, in which the magnetic disk is rotated by a spindle, a test signal is written into the magnetic disk by one magnetic head mounted in one carriage which moves in the radius direction of the magnetic disk, and the test signal of the magnetic disk is read by the other magnetic head mounted in the other carriage which moves in the radius direction of the magnetic disk to inspect the performance of the magnetic head using the read signal, wherein
the one magnetic head mounted in the one carriage or the other magnetic head mounted in the other carriage is continued to be mounted to replace remained magnetic head between the one magnetic head and the other magnetic head, and to conduct a test for the performance of the remained magnetic head.
